(19) United States
(12) Patent Application Publication
(10) Pub. No.: US 2017/0330561 A1
(43) Pub. Date: Nov. 16, 2017

(54) NONLINGUISTIC INPUT FOR NATURAL LANGUAGE GENERATION

(71) Applicant: Intel Corporation, Santa Clara, CA (US)

(72) Inventors: Crystal Annette Nakatsu, San Jose, CA (US); Angel Rodriguez, Sevilla (ES); Jessica M. Christian, Sunnyvale, CA (US); Robert James Firby, San Mateo, CA (US); Jose Gabriel De Amores Carredano, Sevilla, SE (ES); Martin Henk Van Den Berg, Palo Alto, CA (US); Pilar Amores, Sevilla (ES)

(21) Appl. No.: 15/300,574

(22) PCT Filed: Dec. 24, 2015
(86) PCT No.: PCT/EP2015/081244

§ 371 Date: Sep. 29, 2016

(51) Int. Cl. G10L 15/22; G10L 15/26; G10L 13/02

(52) U.S. Cl. CPC G10L 15/22; G10L 15/26; G10L 13/02; G10L 2015/227; G10L 2015/223

(57) ABSTRACT

Embodiments are directed to systems, methods, and devices that are directed to a sensor implemented at least partially in hardware to detect information about a user and a processor implemented at least partially in hardware to determine a state of the user based on the detected information, and select an output mode for a dialog message based on the state of the user. A dialog system implemented at least partially in hardware can be included to configure a dialog message based on the selected output mode; and output the dialog message to the user.

### TECHNICAL FIELD

This disclosure is directed to using nonlinguistic inputs for a natural language generation in a dialog system.

### BACKGROUND

Current state-of-the-art natural language interfaces for applications and smart devices adjust response patterns based on two sources of information: what the user has said to the application, and extraneous information the application sources from the internet and the device.

### BRIEF DESCRIPTION OF THE DRAWINGS

FIG. 1 is a schematic block diagram of a system that includes a dialog system that uses non-linguistic data input in accordance with embodiments of the present disclosure.

FIG. 2 is a schematic block diagram of a biometric input processing system in accordance with embodiments of the present disclosure.

FIG. 3 is a process flow diagram for using nonlinguistic cues for a dialog system.

FIG. 4 is an example illustration of a processor according to an embodiment of the present disclosure.

FIG. 5 is a schematic block diagram of a mobile device in accordance with embodiments of the present disclosure.

FIG. 6 is a schematic block diagram of a computing system according to an embodiment of the present disclosure.

### DETAILED DESCRIPTION

This disclosure describes using sensory information, such as biometric sensors (e.g., heart-rate monitor, footpod, etc.), as a source of nonlinguistic cues for natural language generation. This source of information will be especially useful in calibrating input processing and application responses for fitness, health and wellness applications.

Biometric information can be used to adapt natural language interfaces to provide an enhanced dialog experience. The level of physical exertion or the particular exercise routine performed by the user can have an effect on the way the user communicates with an application and the way the application communicates with the user. This disclosure describes systems, devices, and techniques to make exchanges between a user and application through a dialog system more natural, thereby resulting in an improved user experience.

Input from biometric sensors and/or other sensor can be used to infer the user state. This is combined with other data, including data from the microphone that measures noise levels and voice clues that the user is tired (panting, higher pitch), and also including the current interaction modality (headphones vs. speakers). That information is used to appropriately adjust the output to the user. This information can include what information to give, what style to give the information in, what volume to provide, what modality, and generating the right voice for the output modality.

The models used to generate appropriate responses (e.g., dialog rules, dialog moves, possible responses, application actions and settings, etc.) can be modified and selected based on the specific measurements (or lack thereof) returned by biometric sensors tethered to the smart device running the applications. For example, if the user is running or jogging and using headphones, the dialog system could output positive encouragement through the headphones when user's step rate (as detected by footpod) decreases.

This and other examples are contemplated in this disclosure.

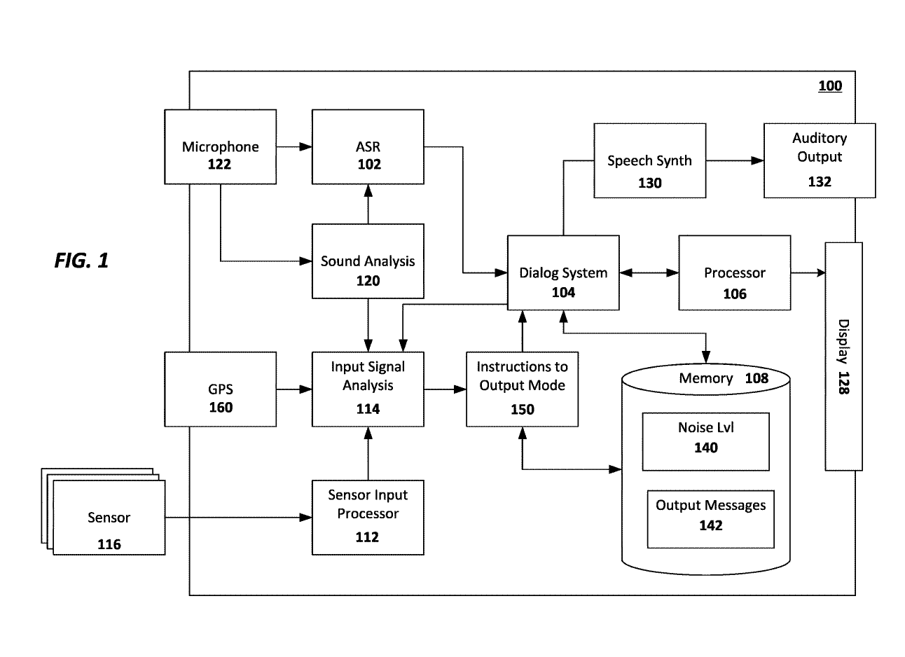

FIG. 1 is a schematic block diagram of a system 100 that includes a dialog system that uses a biometric input in accordance with embodiments of the present disclosure. System 100 can be a mobile phone, tablet, wearable device, personal computer, laptop, desktop computer, or any computing device that can be interfaced by a user through speech.

System 100 includes a dialog system 104, an automatic speech recognition (ASR) system 102, one or more sensors 116, and a microphone 122. The system 100 also includes an auditory output 132 and a display 128.

Generally, the dialog system 104 can receive textual inputs from the ASR system 102 to interpret the speech input and provide an appropriate response, in the form of an executed command, a verbal response (oral or textual), or some combination of the two.

The system 100 also includes a processor 106 for executing instructions from the dialog system 104. The system 100 can also include a speech synthesizer 124 that can synthesize a voice output from the textual speech. System 100 can include an auditory output 132 that outputs audible sounds, including synthesized voice sounds, via a speaker or headphones or Bluetooth connected device, etc. The system 100 also includes a display 128 that can display textual information and images as part of a dialog, as a response to an instruction or inquiry, or for other reasons.

The system 100 may include one or more sensors 116 that can provide a signal into a sensor input processor 112. The sensor 116 can be part of the system 100 or can be part of a separate device, such as a wearable device. The sensor 116 can communicate with the system 100 via Bluetooth, Wifi, wireline, WLAN, etc. Though shown as a single sensor 116, more than one sensor can supply signals to the sensor input processor 112. The sensor 116 can include any type of sensor that can provide external information to the system 100. For example, sensor 116 can include a biometric sensor, such as a heartbeat sensor. Others examples include a pulse oximeter, EEG, sweat sensor, breath rate sensor, pedometer, blood pressure sensor, etc. Other examples of biometric information can include heart rate, stride rate, cadence, breath rate, vocal fry, breathy phonation, amount of sweat, etc. In some embodiments, the sensor 116 can include an inertial sensor to detect vibrations of the user, such as whether the users hands are shaking, etc.

The sensor 116 can provide electrical signals representing sensor data to the sensor input processor 112, which can be implemented in hardware, software, or a combination of hardware and software. The sensor input processor 112 receives electrical signals representing sensory information. The sensor input processor 112 can turn the electrical signals into contextually relevant information. For example, the sensor input processor 112 can translate an electrical signal representing a certain heart rate into formatted information, such as beats/minute. For a inertial sensor, the sensor input processor 112 can translate electrical signals representing movement into how much a user's hand is shaking. For a pedometer, the sensor input processor 112 can translate an electrical signal representing steps into steps/minute. Other examples are readily apparent.

The system 100 can also include a microphone 122 for converting audible sound into corresponding electrical sound signals. The sound signals are provided to the automatic speech recognition (ASR) system 102. The ASR system 102 that can be implemented in hardware, software, or a combination of hardware and software. The ASR system 102 can be communicably coupled to and receive input from a microphone 122. The ASR system 102 can output recognized text in a textual format to a dialog system 104 implemented in hardware, software, or a combination of hardware or software.

In some embodiments, system 100 also includes a global positioning system (GPS) 160 configured to provide location information to system 100. In some embodiments, the GPS 160 can input location information into the dialog system 104 so that the dialog system 104 can use the location information for contextual interpretation of speech text received from the ASR system 102.

Generally, the dialog system 104 can receive textual inputs from the ASR system 102 to interpret the speech input and provide an appropriate response, in the form of an executed command, a verbal response (oral or textual), or some combination of the two. The system 100 also includes a processor 106 for executing instructions from the dialog system 104. The system 100 can also include a speech synthesizer 124 that can synthesize a voice output from the textual speech. System 100 can include an auditory output 132 that outputs audible sounds, including synthesized voice sounds, via a speaker or headphones or Bluetooth connected device, etc. The system 100 also includes a display 128 that can display textual information and images as part of a dialog, as a response to an instruction or inquiry, or for other reasons.

As mentioned previously, the microphone 122 can receive audible speech input and convert the audible speech input into an electronic speech signal (referred to as a speech signal). The electronic speech signal can be provided to the ASR system 102. The ASR system 102 uses linguistic models to convert the electronic speech signal into a text format of words, such as a sentence or sentence fragment representing a user's request or instruction to the system 100.

The microphone 122 can also receive audible background noise. Audible background noise can be received at the same time as the audible speech input or can be received upon request by the dialog system 100 independent of the audible speech input. The microphone 122 can convert the audible background noise into an electrical signal representative of the audible background noise (referred to as a noise signal).

The noise signal can be processed by a sound analysis processor 120 implemented in hardware, software, or a combination of hardware and software. The sound analysis processor 120 can be part of the ASR system 102 or can be a separate hardware and/or software module. In some embodiments, a single signal that includes both the speech signal and the noise signal are provided to the sound analysis processor 120. The sound analysis processor 120 can determines a signal to noise ratio (SNR) of the speech signal to the noise signal. The SNR represents a level of background noise that may be interfering with the audible speech input. In some embodiments, the sound analysis processor 120 can determine a noise level of the background noise.

In some embodiments, a speech signal (which may coincidentally include a noise signal) can be provided to the ASR system 102. The ASR system 102 can recognize the speech signal and covert the recognized speech signal into a textual format without addressing the background noise. The textual format of the recognized speech signal can be referred to as recognized speech, but it is understood that recognized speech is in a format compatible with the dialog system 104.

The dialog system 104 can receive the recognized speech from the ASR system 102. The dialog system 104 can interpret the recognized speech to identify what the speaker wants. For example, the dialog system 104 can include a parser for parsing the recognized speech and an intent classifier for identifying intent from the parsed recognized speech.

In some embodiments, the system 100 can also include a speech synthesizer 130 that can synthesize a voice output from the textual speech. System 100 can include a auditory output 132 that outputs audible sounds, including synthesized voice sounds.

In some embodiments, the system 100 can also include a display 128 that can display textual information and images as part of a dialog, as a response to an instruction or inquiry, or for other reasons.

The system 100 can include a memory 108 implemented at least partially in hardware. The memory 108 can store data that assists the system 100 in providing the user an enhanced dialog. For example, the memory 108 can store a predetermined noise level threshold value 140. The noise level threshold value 140 can be a numeric value against which the noise level from the microphone is compared to determine whether the dialog system 104 needs to elevate output volume for audible dialog responses or change from an auditory output to an image-based output, such as a text output.

The memory 108 can also store a message 142. The message 142 can be a generic message provided to the user when the dialog system 104 determines that such an output is appropriate for the dialog. The dialog system 104 can use nonlinguistic cues to alter the output modality of predetermined messages, such as raising the volume of the synthesized speech or outputting the message as a text message.

In some embodiments, the dialog system 100 can use nonlinguistic cues to provide output messages tailored to the user's state. The example about the jogger is one example.

The sensor 116 can provide sensor signals to a sensor input processor 112. The sensor input processor 112 processes the sensor input to translate that sensor information into a format that is readable by the input signal analysis processor 114. Input analysis processor 114 is implemented in hardware, software, or a combination of hardware and software. The input signal analysis processor 114 can also receive a noise level from sound analysis processor.

Sound analysis processor 120 can be implemented in hardware, software, or a combination of hardware and software. Sound analysis processor 120 can receive a sound signal that includes background noise from the microphone and determine a noise level or signal to noise ratio from the sound signal. The sound analysis processor 120 can then provide the noise level or SNR to the input signal analysis processor 114.

Additionally, the sound analysis processor 120 can be configured to determine information about the speaker based on the rhythm of the speech, spacing between words, sentence structure, diction, volume, pitch, breathing sounds, slurring, etc. The sound analysis processor 120 can qualify these data and suggest a state of the user to the input signal analysis processor 114. Additionally, the information about the user can also be provided to the ASR 102, which can use the state information about the user to select a linguistic model for recognizing speech.

The input signal analysis processor 114 can receive inputs from the sensor input processor 112 and the sound analysis processor 120 to make a determination as to the state of the user. The state of the user can include information pertaining to what the user is doing, where the user is, whether the user can receive audible messages or graphical messages, or other information that allows the system 100 to relay information to the user in an effective way. The input signal analysis processor 114 uses one or more sensor information to make a conclusion about the state of the user. For example, the input signal analysis can use a heart rate of the user to conclude that the user is exercising. In some embodiments, more than one sensor information can be used to increase the accuracy of the input signal analysis processor 114. For example, a heart rate of the user and a pedometer signal can be used to conclude that the user is walking or running. The GPS 160 can also be used to help the input signal analysis processor 114 that the user is running in a hilly area. So, the more sensory input, the greater the potential for making an accurate conclusion as to the state of the user.

The input signal analysis can conclude the state of the user and provide an instruction to the output mode 150. The instruction to the output mode 150 can change or confirm the output mode of a dialog message to the user. For example, if the user is running, the user is unlikely to be looking at the system 100. So, the instruction to output mode 150 can change from a graphical output on a display 128 to an audible output 132 via speakers or headphones.

In some embodiments, the instructions to output mode 150 can also change a volume of the output, an inflection of the output (e.g., an inflection synthesized by the speech synthesizer 130), etc.

In some embodiments, the instruction to output mode 150 can change the volume of the dialog. In addition, the instruction to output mode 150 can also inform the dialog system 104 about the concluded reasons for why the user may not be able to hear an auditory message or why the user may not be understandable.

For example, if there is high background noise, the user's speech input may not be understandable or cannot be heard, so the dialog system 104 can select a dialog message 142 that tell the user that there is too much background noise. But if there is little background noise, but the user is speaking too quietly, the dialog system 104 can select a dialog message 142 that informs the user that they are speaking too softly. In both cases, the system 100 cannot accurately process input speech, but the reasons are different. The dialog system 104 can use the instructions to output mode 150 select an appropriate output message based on the concluded state of the user.

Auditory output 132 can include a speaker, a headphone output, a Bluetooth connected device, etc.

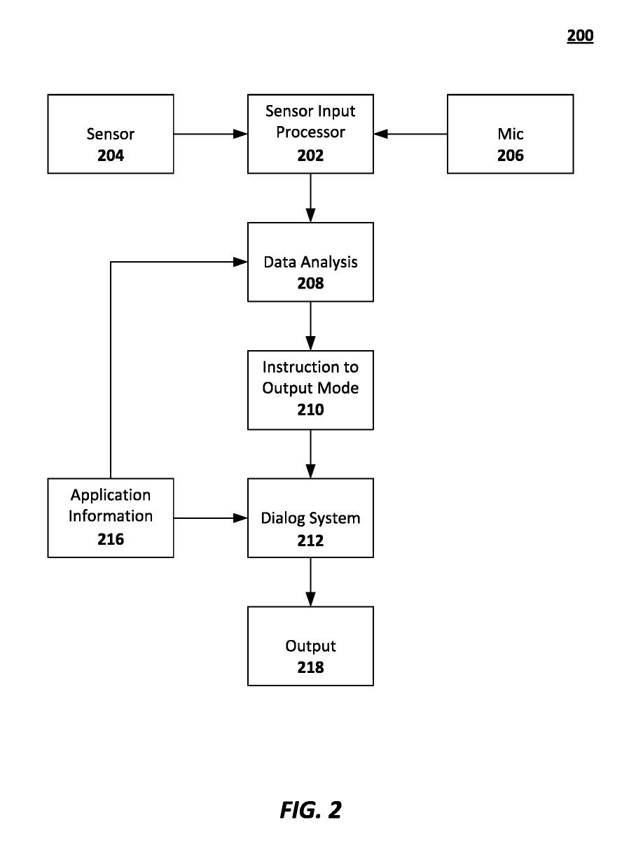

FIG. 2 is a schematic block diagram of a device 200 that uses nonlinguistic input for a dialog system. The device 200 includes a dialog system 212 that is configured to provide dialog messages through an output (oral or graphical) to a user. The dialog system can include a natural language unit (NLU) and a next move module.

The device 200 also includes a sensor input processor 202 that can receive sensor input from one or more sensors, such as biometric sensors, GPS, microphones, etc. The sensor input processor 202 can processes each sensory input to translate the sensory input into a format that is understandable. The data analysis processor 208 can receive translated sensory input to draw conclusions about the state of a user of the device 200. The state can include anything that informs the dialog system 212 about how to provide output to the user, such as what the user is doing (heart rate, pedometer, inertial sensor, etc.), how the user is interacting the with the device (headphones, speakers, viewing movies, etc.), where the user is (GPS, thermometer, etc.), what is happening around the user (background noise, etc.), how well the user is able to communicate (background noise, static, interruptions in vocal patterns, etc.), as well as other state information.

The state of the user can be provided to the instruction to output mode module 210. The instruction to output mode module can consider current output modalities as well as the conclusions about the state of the user to determine an output modality for a dialog message. The instruction to output mode module 210 can provide a recommendation or instruction to the dialog system 212 about the output modality to use for the dialog message.

In this disclosure, the term “output modality” includes the manner by which the dialog should output a message, such as by audio or by graphical user interface, such as a text or picture. Output modality can also include the volume of the audible message, the inflection of the audible message, the message itself, the text size of a text message, the level of detail in the message, etc.

The dialog system 212 can also consider application information 216. Application information 216 can include additional information about the user's state and/or the content of the dialog. Examples of application information 216 can include an events calendar, an alarm, applications running on a smart phone or computer, notifications, e-mail or text alerts, sound settings, do-not-disturb settings, etc. The application information 216 can provide both a trigger for the dialog system 212 to begin a dialog or can provide further nonlinguistic contextual cues for the dialog system 212 to provide the user with an enhanced dialog experience.

For example, if the user has set an alarm to wake up, a sensor that monitors sleeping patterns can provide sleep information to the device 200 that informs the device 200 that the user is asleep and can tune a dialog message to wake the user up by adjusting volume and playback messages, music, tones, etc. But if the user set the alarm and the sleep sensor determines that the user is awake, the dialog system 212 can forgo the alarm or provide a lower volume or provide a message asking whether the user wants the alarm to go off, etc.

As another example, a calendar event may trigger the dialog system 212 to provide a notification to the user. A sensor may indicate that the user cannot view the calendar alert because the user is performing an action and is not looking at the device 200. The dialog system 212 can provide an auditory message about the calendar event instead of a textual message. The user may be driving (GPS sensor, car's internal sensors for an in-car dialog system, car's connectivity to the smart phone, smart phone's inertial sensors) or exercising (heart rate sensor, pedometer, calendar) and may not be able to view the screen. So the dialog system 212 can automatically provide the user with an audible message instead of a graphical message. In this example, the calendar can also act as a nonlinguistic cue for output modality: by considering that a user may have running on his/her calendar, the dialog system 212 can adjust the output modality to better engage with the user.

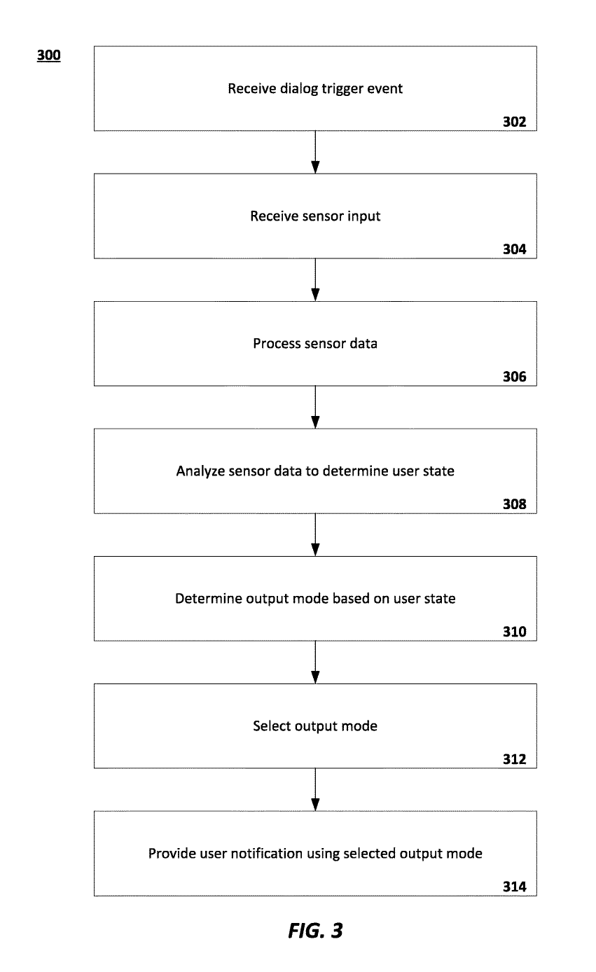

FIG. 3 is a process flow diagram 300 for using nonlinguistic cues for a dialog system. A dialog triggering event can be received by, for example, a dialog system (302). The dialog triggering event can be an incoming message, such as a phone call or text or e-mail alert, or the triggering event can be an application-triggered event, such as a calendar alert, social media notification, etc., or the triggering event can be a request for a dialog from a user.

One or more sensory inputs can be received (304). The sensory input can be processed to translate the signal into something understandable by the rest of the system, such as a numeric value and metadata (306). The sensory input can be analyzed to make a conclusion as to the user state (308). Based on the user's sate, a recommended output modality can be provided to a dialog system for the dialog message (310). The output modality can be selected (312). The output modality can include a selection from auditory output or graphical output or tactile output; but output modality can also include volume, inflection, message type, text size, graphic, etc. The system can then provide the dialog message to the user using the determined output modality (314).

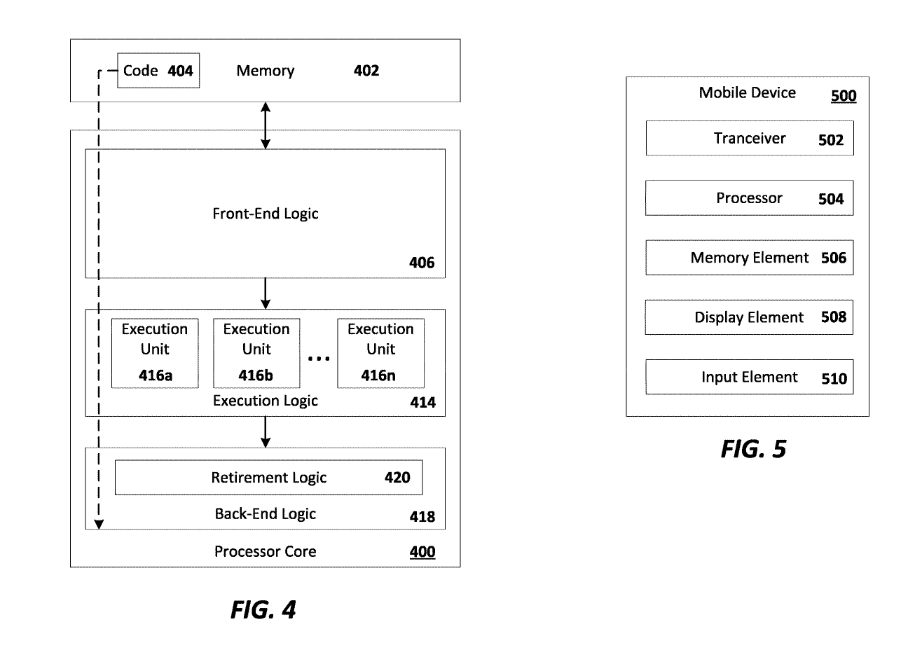

FIGS. 4-6 are block diagrams of exemplary computer architectures that may be used in accordance with embodiments disclosed herein. Other computer architecture designs known in the art for processors, mobile devices, and computing systems may also be used. Generally, suitable computer architectures for embodiments disclosed herein can include, but are not limited to, configurations illustrated in FIGS. 4-6.

FIG. 4 is an example illustration of a processor according to an embodiment. Processor 400 is an example of a type of hardware device that can be used in connection with the implementations above.

Processor 400 may be any type of processor, such as a microprocessor, an embedded processor, a digital signal processor (DSP), a network processor, a multi-core processor, a single core processor, or other device to execute code. Although only one processor 400 is illustrated in FIG. 4, a processing element may alternatively include more than one of processor 400 illustrated in FIG. 4. Processor 400 may be a single-threaded core or, for at least one embodiment, the processor 400 may be multi-threaded in that it may include more than one hardware thread context (or “logical processor”) per core.

FIG. 4 also illustrates a memory 402 coupled to processor 400 in accordance with an embodiment. Memory 402 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 400 can execute any type of instructions associated with algorithms, processes, or operations detailed herein. Generally, processor 400 can transform an element or an article (e.g., data) from one state or thing to another state or thing.

Code 404, which may be one or more instructions to be executed by processor 400, may be stored in memory 402, or may be stored in software, hardware, firmware, or any suitable combination thereof, or in any other internal or external component, device, element, or object where appropriate and based on particular needs. In one example, processor 400 can follow a program sequence of instructions indicated by code 404. Each instruction enters a front-end logic 406 and is processed by one or more decoders 408. The decoder may generate, as its output, a micro operation such as a fixed width micro operation in a predefined format, or may generate other instructions, microinstructions, or control signals that reflect the original code instruction. Front-end logic 406 also includes register renaming logic 410 and scheduling logic 412, which generally allocate resources and queue the operation corresponding to the instruction for execution.

Processor 400 can also include execution logic 414 having a set of execution units 416a, 416b, 416n, etc. Some embodiments may include a number of execution units dedicated to specific functions or sets of functions. Other embodiments may include only one execution unit or one execution unit that can perform a particular function. Execution logic 414 performs the operations specified by code instructions.

After completion of execution of the operations specified by the code instructions, back-end logic 418 can retire the instructions of code 404. In one embodiment, processor 400 allows out of order execution but requires in order retirement of instructions. Retirement logic 420 may take a variety of known forms (e.g., re-order buffers or the like). In this manner, processor 400 is transformed during execution of code 404, at least in terms of the output generated by the decoder, hardware registers and tables utilized by register renaming logic 410, and any registers (not shown) modified by execution logic 414.

Although not shown in FIG. 4, a processing element may include other elements on a chip with processor 400. For example, a processing element may include memory control logic along with processor 400. The processing element may include I/O control logic and/or may include I/O control logic integrated with memory control logic. The processing element may also include one or more caches. In some embodiments, non-volatile memory (such as flash memory or fuses) may also be included on the chip with processor 400.

Referring now to FIG. 5, a block diagram is illustrated of an example mobile device 500. Mobile device 500 is an example of a possible computing system (e.g., a host or endpoint device) of the examples and implementations described herein. In an embodiment, mobile device 500 operates as a transmitter and a receiver of wireless communications signals. Specifically, in one example, mobile device 500 may be capable of both transmitting and receiving cellular network voice and data mobile services. Mobile services include such functionality as full Internet access, downloadable and streaming video content, as well as voice telephone communications.

Mobile device 500 may correspond to a conventional wireless or cellular portable telephone, such as a handset that is capable of receiving “3G”, or “third generation” cellular services. In another example, mobile device 500 may be capable of transmitting and receiving “4G” mobile services as well, or any other mobile service.

Examples of devices that can correspond to mobile device 500 include cellular telephone handsets and smartphones, such as those capable of Internet access, email, and instant messaging communications, and portable video receiving and display devices, along with the capability of supporting telephone services. It is contemplated that those skilled in the art having reference to this specification will readily comprehend the nature of modern smartphones and telephone handset devices and systems suitable for implementation of the different aspects of this disclosure as described herein. As such, the architecture of mobile device 500 illustrated in FIG. 5 is presented at a relatively high level. Nevertheless, it is contemplated that modifications and alternatives to this architecture may be made and will be apparent to the reader, such modifications and alternatives contemplated to be within the scope of this description.

In an aspect of this disclosure, mobile device 500 includes a transceiver 502, which is connected to and in communication with an antenna. Transceiver 502 may be a radio frequency transceiver. Also, wireless signals may be transmitted and received via transceiver 502. Transceiver 502 may be constructed, for example, to include analog and digital radio frequency (RF) ‘front end’ functionality, circuitry for converting RF signals to a baseband frequency, via an intermediate frequency (IF) if desired, analog and digital filtering, and other conventional circuitry useful for carrying out wireless communications over modern cellular frequencies, for example, those suited for 3G or 4G communications. Transceiver 502 is connected to a processor 504, which may perform the bulk of the digital signal processing of signals to be communicated and signals received, at the baseband frequency. Processor 504 can provide a graphics interface to a display element 508, for the display of text, graphics, and video to a user, as well as an input element 510 for accepting inputs from users, such as a touchpad, keypad, roller mouse, and other examples. Processor 504 may include an embodiment such as shown and described with reference to processor 400 of FIG. 4.

In an aspect of this disclosure, processor 504 may be a processor that can execute any type of instructions to achieve the functionality and operations as detailed herein. Processor 504 may also be coupled to a memory element 506 for storing information and data used in operations performed using the processor 504. Additional details of an example processor 504 and memory element 506 are subsequently described herein. In an example embodiment, mobile device 500 may be designed with a system-on-a-chip (SoC) architecture, which integrates many or all components of the mobile device into a single chip, in at least some embodiments.

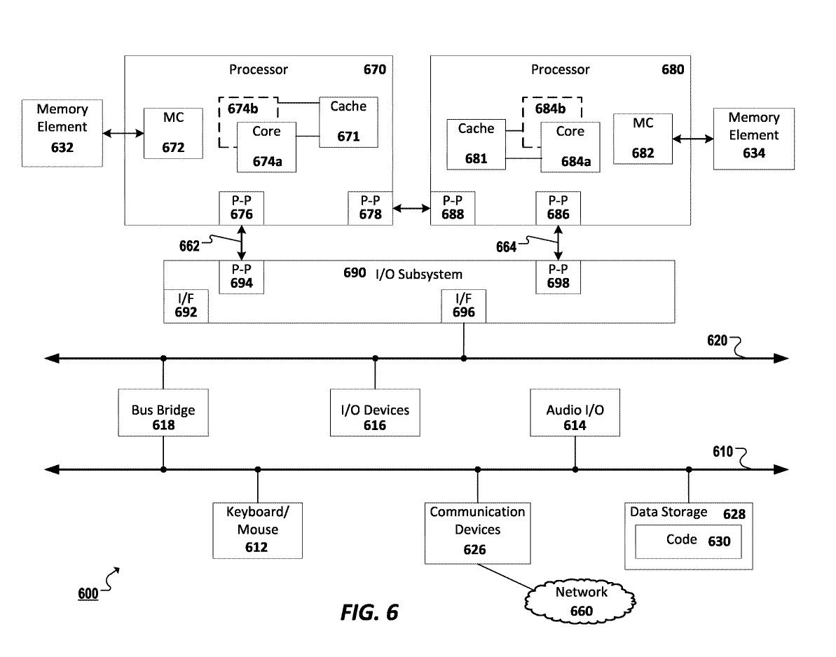

FIG. 6 is a schematic block diagram of a computing system 600 according to an embodiment. In particular, FIG. 6 shows a system where processors, memory, and input/output devices are interconnected by a number of point-to-point interfaces. Generally, one or more of the computing systems described herein may be configured in the same or similar manner as computing system 600.

Processors 670 and 680 may also each include integrated memory controller logic (MC) 672 and 682 to communicate with memory elements 632 and 634. In alternative embodiments, memory controller logic 672 and 682 may be discrete logic separate from processors 670 and 680. Memory elements 632 and/or 634 may store various data to be used by processors 670 and 680 in achieving operations and functionality outlined herein.

Processors 670 and 680 may be any type of processor, such as those discussed in connection with other figures. Processors 670 and 680 may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration capable of achieving the functionality and features of examples and implementations provided herein.

Example 1 is a device that includes a sensor implemented at least partially in hardware to detect information about a user; a processor implemented at least partially in hardware to determine a state of the user based on the detected information, and select an output mode for a dialog message based on the state of the user; and a dialog system implemented at least partially in hardware to configure a dialog message based on the selected output mode; and output the dialog message to the user.

Example 2 may include the subject matter of example 1, wherein the sensor comprises one or more of a biometric sensor, an inertial sensor, a positioning sensor, or a sound sensor.

Example 3 may include the subject matter of any of examples 1 or 2, wherein the sensor comprises a microphone.

Example 4 may include the subject matter of any of examples 1 or 2 or 3, further comprising a sound input processor to receive a sound signal; determine a background noise of the sound signal; and provide the background noise to the processor; and wherein the processor is configured to determine the state of the user based on the background noise of the received sound signal.

Example 5 may include the subject matter of any of examples 1 or 2 or 3 or 4, further comprising an automatic speech recognition (ASR) system implemented at least partially in hardware, the ASR system to receive a sound signal, the sound signal comprising a signal representing audible speech; translate the sound signal into recognizable text; and determine one or more speech patterns based on translating the sound signal into recognizable text; and wherein the processor is configured to determine the state of the user based on the speech patterns.

Example 6 may include the subject matter of any of examples 1 or 2 or 3 or 4 or 5, wherein the output mode comprises one or a combination of an auditory output mode, a graphical output mode, or a tactile output mode.

Example 7 may include the subject matter of example 6, further comprising a display, wherein the graphical output mode comprises textual messages displayed on the display.

Example 8 may include the subject matter of any of examples 1 or 2 or 3 or 4 or 5 or 6 or 7, wherein the output mode comprises one or a combination of an auditory volume, an auditory inflection, an auditory pitch, a text size, or a vibration level.

Example 9 may include the subject matter of any of examples 1 or 2 or 3 or 4 or 5 or 6 or 7 or 8, further comprising a speech synthesizer implemented at least partially in hardware to synthesize an audible output of a dialog message, the speech synthesizer configured to output audible speech comprising a volume, pitch, or inflection based on the selected output mode.

Example 10 may include the subject matter of any of examples 1 or 2 or 3 or 4 or 5 or 6 or 7 or 8 or 9, further comprising an application to provide notification information to the dialog system, wherein the dialog system is configured to use the notification information to configure the dialog message to the user.

Example 11 is a method that includes detecting information about a user; determining a state of the user based on the detected information, selecting an output mode for a dialog message based on the state of the user; configuring a dialog message based on the selected output mode; and outputting the dialog message to the user based on the output mode.

Example 12 may include the subject matter of example 11, wherein detecting information about the user comprises sensing one or more of biometric information, an inertial information, a positioning information, or a sound information.

Example 13 may include the subject matter of any of examples 11 or 12, further comprising receiving a sound signal; determining a background noise of the sound signal; and providing the background noise to the processor; and wherein determining the state of the user comprises determine the state of the user based on the background noise of the received sound signal.

Example 14 may include the subject matter of any of examples 11 or 12 or 13, further comprising receiving a sound signal, the sound signal comprising a signal representing audible speech; translating the sound signal into recognizable text; and determining one or more speech patterns based on translating the sound signal into recognizable text; and wherein determining the state of the user comprises determining the state of the user based on the speech patterns.

Example 15 may include the subject matter of any of examples 11 or 12 or 13 or 14, wherein the output mode comprises one or a combination of an auditory output mode, a graphical output mode, or a tactile output mode.

Example 16 may include the subject matter of example 15, further comprising displaying the dialog message if the output mode comprises textual messages or graphical messages.

Example 17 may include the subject matter of any of examples 11 or 12 or 13 or 14 or 15, wherein the output mode comprises one or a combination of an auditory volume, an auditory inflection, an auditory pitch, a text size, or a vibration level.

Example 18 may include the subject matter of any of examples 11 or 12 or 13 or 14 or 15 or 17, further comprising synthesizing an audible output of the dialog message, the synthesized audible output configured to output audible speech comprising a volume, pitch, or inflection based on the selected output mode.

Example 19 may include the subject matter of any of examples 11 or 12 or 13 or 14 or 15, further comprising providing notification information to the dialog system, wherein the dialog system is configured to use the notification information to configure the dialog message to the user.

Example 20 is a system that includes a sensor implemented at least partially in hardware to detect information about a user; a processor implemented at least partially in hardware to determine a state of the user based on the detected information and select an output mode for a dialog message based on the state of the user; a dialog system implemented at least partially in hardware to configure a dialog message based on the selected output mode and output the dialog message to the user; a memory to store dialog messages; and an automatic speech recognition (ASR) system implemented at least partially in hardware, the ASR system to receive a sound signal, the sound signal comprising a signal representing audible speech, translate the sound signal into recognizable text; and determine one or more speech patterns based on translating the sound signal into recognizable text.

Example 21 may include the subject matter of example 20, wherein the sensor comprises one or more of a biometric sensor, an inertial sensor, a positioning sensor, or a sound sensor.

Example 22 may include the subject matter of any of examples 20 or 21, wherein the sensor comprises a microphone.

Example 23 may include the subject matter of any of examples 20 or 21 or 22, further comprising a sound input processor to receive a sound signal; determine a background noise of the sound signal; and provide the background noise to the processor; and wherein the processor is configured to: determine the state of the user based on the background noise of the received sound signal.

Example 24 may include the subject matter of any of examples 20 or 21 or 22 or 23, wherein the processor is configured to determine the state of the user based on the speech patterns.

Example 25 may include the subject matter of any of examples 20 or 21 or 22 or 23 or 24, wherein the output mode comprises one or a combination of an auditory output mode, a graphical output mode, or a tactile output mode.

Example 26 may include the subject matter of example 25, further comprising a display, wherein the graphical output mode comprises textual messages displayed on the display.

Example 27 may include the subject matter of any of examples 20 or 21 or 22 or 23 or 24 or 25, wherein the output mode comprises one or a combination of an auditory volume, an auditory inflection, an auditory pitch, a text size, or a vibration level.

Example 28 may include the subject matter of any of examples 20 or 21 or 22 or 23 or 24 or 25 or 27, further comprising a speech synthesizer implemented at least partially in hardware to synthesize an audible output of a dialog message, the speech synthesizer configured to output audible speech comprising a volume, pitch, or inflection based on the selected output mode.

Example 29 may include the subject matter of any of examples 20 or 21 or 22 or 23 or 24 or 25 or 27 or 28, further comprising an application to provide notification information to the dialog system, wherein the dialog system is configured to use the notification information to configure the dialog message to the user.

Example 30 is a computer program product tangibly embodied on non-transient computer readable media, the computer program product comprising instructions operable when executed to detect information about a user; determine a state of the user based on the detected information, select an output mode for a dialog message based on the state of the user; configure a dialog message based on the selected output mode; and output the dialog message to the user based on the output mode.

Example 31 may include the subject matter of example 30, wherein detecting information about the user comprises sensing one or more of biometric information, an inertial information, a positioning information, or a sound information.

Example 32 may include the subject matter of any of examples 30 or 31, the instructions further operable to receive a sound signal; determine a background noise of the sound signal; and provide the background noise to the processor; and wherein determining the state of the user comprises determine the state of the user based on the background noise of the received sound signal.

Example 33 may include the subject matter of any of examples 30 or 31 or 32, the instructions further operable to receive a sound signal, the sound signal comprising a signal representing audible speech; translate the sound signal into recognizable text; and determine one or more speech patterns based on translating the sound signal into recognizable text; and wherein determining the state of the user comprises determining the state of the user based on the speech patterns.

Example 34 may include the subject matter of any of examples 30 or 31 or 32 or 33, wherein the output mode comprises one or a combination of an auditory output mode, a graphical output mode, or a tactile output mode.

Example 35 may include the subject matter of example 34, the instructions further operable to display the dialog message if the output mode comprises textual messages or graphical messages.

Example 36 may include the subject matter of any of examples 30 or 31 or 32 or 33 or 34, wherein the output mode comprises one or a combination of an auditory volume, an auditory inflection, an auditory pitch, a text size, or a vibration level.

Example 37 may include the subject matter of any of examples 30 or 31 or 32 or 33 or 34 or 36, the instructions further operable to synthesize an audible output of the dialog message, the synthesized audible output configured to output audible speech comprising a volume, pitch, or inflection based on the selected output mode.

Example 38 may include the subject matter of any of examples 30 or 31 or 32 or 33 or 34 or 36 or 37, the instructions further operable to provide notification information to the dialog system, wherein the dialog system is configured to use the notification information to configure the dialog message to the user.

Advantages of the present disclosure are readily apparent to those of skill in the art. Among the various advantages of the present disclosure include providing an enhanced user experience for a dialog between a user and a device.

While this specification contains many specific implementation details, these should not be construed as limitations on the scope of any disclosures or of what may be claimed, but rather as descriptions of features specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. A device comprising:
a sensor to detect information about a user;
a processor to:
determine a state of the user based on the detected information, and
select an output mode for a dialog message based on the state of the user; and
a dialog system to:
configure a dialog message based on the selected output mode; and
output the dialog message to the user.

2. The device of claim 1, wherein the sensor comprises one or more of a biometric sensor, an inertial sensor, a positioning sensor, or a sound sensor.

3. The device of claim 1, wherein the sensor comprises a microphone.

4. The device of claim 1, further comprising a sound input processor to:
receive a sound signal;
determine a background noise of the sound signal; and
provide the background noise to the processor; and
wherein the processor is configured to:
determine the state of the user based on the background noise of the received sound signal.

5. The device of claim 1, further comprising an automatic speech recognition (ASR) system implemented at least partially in hardware, the ASR system to:
receive a sound signal, the sound signal comprising a signal representing audible speech;
translate the sound signal into recognizable text; and
determine one or more speech patterns based on translating the sound signal into recognizable text; and
wherein the processor is configured to:
determine the state of the user based on the speech patterns.

6. The device of claim 1, wherein the output mode comprises one or a combination of an auditory output mode, a graphical output mode, or a tactile output mode.

7. The device of claim 6, further comprising a display, wherein the graphical output mode comprises textual messages displayed on the display.

8. The device of claim 1, wherein the output mode comprises one or a combination of an auditory volume, an auditory inflection, an auditory pitch, a text size, or a vibration level.

9. The device of claim 1, further comprising a speech synthesizer implemented at least partially in hardware to synthesize an audible output of a dialog message, the speech synthesizer configured to output audible speech comprising a volume, pitch, or inflection based on the selected output mode.

10. The device of claim 1, further comprising an application to provide notification information to the dialog system, wherein the dialog system is configured to use the notification information to configure the dialog message to the user.

11. A method comprising:
detecting information about a user;
determining a state of the user based on the detected information,
selecting an output mode for a dialog message based on the state of the user;
configuring a dialog message based on the selected output mode; and
outputting the dialog message to the user based on the output mode.

12. The method of claim 11, wherein detecting information about the user comprises sensing one or more of biometric information, an inertial information, a positioning information, or a sound information.

13. The method of claim 11, further comprising:
receiving a sound signal;
determining a background noise of the sound signal; and
providing the background noise to the processor; and
wherein determining the state of the user comprises determine the state of the user based on the background noise of the received sound signal.

14. The method of claim 11, further comprising:
receiving a sound signal, the sound signal comprising a signal representing audible speech;
translating the sound signal into recognizable text; and
determining one or more speech patterns based on translating the sound signal into recognizable text; and
wherein determining the state of the user comprises determining the state of the user based on the speech patterns.

15. The method of claim 11, wherein the output mode comprises one or a combination of an auditory output mode, a graphical output mode, or a tactile output mode.

16. The method of claim 15, further comprising displaying the dialog message if the output mode comprises textual messages or graphical messages.

17. The method of claim 11, wherein the output mode comprises one or a combination of an auditory volume, an auditory inflection, an auditory pitch, a text size, or a vibration level.

18. The method of claim 11, further comprising synthesizing an audible output of the dialog message, the synthesized audible output configured to output audible speech comprising a volume, pitch, or inflection based on the selected output mode.

19. The method of claim 11, further comprising providing notification information to the dialog system, wherein the dialog system is configured to use the notification information to configure the dialog message to the user.

20. A system comprising:
a sensor to detect information about a user;
a processor to:
determine a state of the user based on the detected information, and
select an output mode for a dialog message based on the state of the user;
a dialog system to:
configure a dialog message based on the selected output mode; and
output the dialog message to the user;
a memory to store dialog messages; and
an automatic speech recognition (ASR) system to:
receive a sound signal, the sound signal comprising a signal representing audible speech;
translate the sound signal into recognizable text; and
determine one or more speech patterns based on translating the sound signal into recognizable text.

21. The system of claim 20, wherein the sensor comprises one or more of a biometric sensor, an inertial sensor, a positioning sensor, or a sound sensor.

22. The system of claim 21, wherein the sensor comprises a microphone.

23. The system of claim 20, further comprising a sound input processor to:
receive a sound signal;
determine a background noise of the sound signal; and
provide the background noise to the processor; and
wherein the processor is configured to:
determine the state of the user based on the background noise of the received sound signal.

24. The system of claim 20, wherein the processor is configured to determine the state of the user based on the speech patterns.

25. The system of claim 20, wherein the output mode comprises one or a combination of an auditory output mode, a graphical output mode, or a tactile output mode.
